(19) United States
(12) Patent Application Publication
(10) Pub. No.: US 2026/0081443 A1
(43) Pub. Date: Mar. 19, 2026

(54) BATTERY POWER MANAGEMENT PROTECTION BOARD, QUICK SHUTDOWN METHOD AND QUICK DISCHARGE CIRCUIT THEREOF

(71) Applicant: Acer Incorporated, New Taipei City (TW)

(72) Inventor: Jiunn-Jou LIN, New Taipei City (TW)

(73) Assignee: Acer Incorporated, New Taipei City (TW)

(21) Appl. No.: 19/226,839

(22) Filed: Jun. 3, 2025

(30) Foreign Application Priority Data
Sep. 18, 2024 (TW) 113135262

(51) Int. Cl. H02J 7/00

(52) U.S. Cl. CPC H02J 7/663; H02J 7/80; H02J 7/855; H02J 7/96

(57) ABSTRACT

A battery power management protection board, a quick shutdown method and a quick discharge circuit thereof are provided. The quick shutdown method for the battery power management protection boar includes: receiving a battery voltage to input a first divided voltage to a comparator; receiving a discharge switch control voltage to input a second divided voltage to the comparator; outputting a conduction voltage, if the comparator determines that the first divided voltage is higher than the second divided voltage; receiving, by a ground path switch, the conduction voltage to turn on a ground path; and discharging a remaining capacitance of the battery power management protection board rapidly through the ground path.

This application claims the benefit of Taiwan application Serial No. 113135262, filed Sep. 18, 2024, the disclosure of which is incorporated by reference herein in its entirety.

### TECHNICAL FIELD

The disclosure relates in general to a circuit board and a controlling method thereof, and more particularly to a battery power management protection board, a quick shutdown method and a quick discharge circuit thereof.

### BACKGROUND

A battery power management protection board is typically disposed between a battery and a load. The battery power management protection board could control the charging and discharging behaviors of the battery through switches.

Furthermore, the battery power management protection board could provide protection for the battery through a fuse circuit or a switch.

### SUMMARY

The disclosure is directed to a battery power management protection board, a quick shutdown method thereof, and a quick discharge circuit. The quick discharge circuit provides a ground path to rapidly discharge the remaining capacitance of the battery power management protection board, thereby improving the shutdown speed of the power management protection board.

According to one embodiment, a quick shutdown method for a battery power management protection board is provided. The quick shutdown method for the battery power management protection boar includes: receiving a battery voltage to input a first divided voltage to a comparator; receiving a discharge switch control voltage to input a second divided voltage to the comparator; outputting a conduction voltage, if the comparator determines that the first divided voltage is higher than the second divided voltage; receiving, by a ground path switch, the conduction voltage to turn on a ground path; and discharging a remaining capacitance of the battery power management protection board rapidly through the ground path.

According to another embodiment, a quick discharge circuit is provided. The quick discharge circuit is disposed in a battery power management protection board. The quick discharge circuit includes a first voltage dividing circuit, a second voltage dividing circuit, a comparator, a ground path and a ground path switch. The first voltage dividing circuit is connected to a battery, for receiving a battery voltage and outputting a first divided voltage. The second voltage dividing circuit is connected to a discharge switch, for receiving a discharge switch control voltage and outputting a second divided voltage. The comparator has a first input terminal, a second input terminal, and an output terminal. The first input terminal is connected to the first voltage dividing circuit to receive the first divided voltage, and the second input terminal is connected to the second voltage dividing circuit to receive the second divided voltage. The ground path switch is connected between the output terminal of the comparator and the ground path. When the comparator determines that the first divided voltage is higher than the second divided voltage, the comparator outputs a conduction voltage to the ground path switch to turn on the ground path. Through the ground path, a remaining capacitance of the battery power management protection board is discharged rapidly.

According to an alternative embodiment, a battery power management protection board is provided. The battery power management protection board is connected to a battery. The battery power management protection board includes a first voltage dividing circuit, a second voltage dividing circuit, a comparator, a ground path and a ground path switch. The discharge switch is connected to the battery. The quick discharge circuit includes a first voltage dividing circuit, a second voltage dividing circuit and a comparator. The first voltage dividing circuit is connected to the battery, for receiving a battery voltage and outputting a first divided voltage. The second voltage dividing circuit is connected to the discharge switch, for receiving a discharge switch control voltage and outputting a second divided voltage. The comparator has a first input terminal, a second input terminal, and an output terminal. The first input terminal is connected to the first voltage dividing circuit to receive the first divided voltage, and the second input terminal is connected to the second voltage dividing circuit to receive the second divided voltage. The ground path switch is connected between the output terminal of the comparator and the ground path. When the comparator determines that the first divided voltage is higher than the second divided voltage, the comparator outputs a conduction voltage to the ground path switch to turn on the ground path. Through the ground path, a remaining capacitance of the battery power management protection board is discharged rapidly.

### BRIEF DESCRIPTION OF THE DRAWINGS

FIG. 1 illustrates a schematic diagram of a battery, a battery power management protection board, and a load according to an embodiment of the present disclosure.

FIG. 2 illustrates a control waveform diagram during shutdown of the battery power management protection board 1000′ according to an embodiment of the present disclosure.

FIG. 3 illustrates a block diagram of the battery, the battery power management protection board, and the load according to an embodiment of the present disclosure.

FIG. 4 illustrates a flowchart of the operation method of the battery power management protection board according to an embodiment of the present disclosure.

FIG. 5 illustrates a detailed circuit diagram of the fast discharge circuit according to an embodiment.

FIG. 6 illustrates a detailed flowchart of the fast shutdown method of the battery power management protection board according to an embodiment of the present disclosure.

FIG. 7 illustrates a control waveform diagram during shutdown of the battery power management protection board using the fast discharge circuit 300 according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

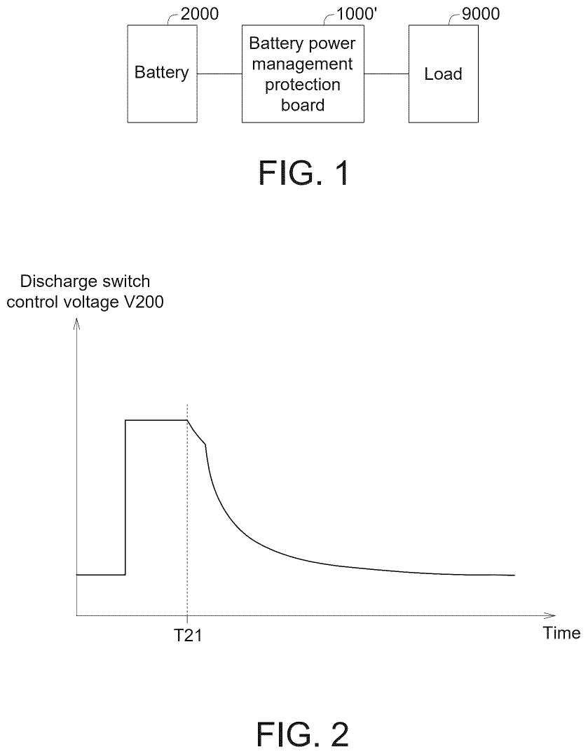

Please refer to FIG. 1, which illustrates a schematic diagram of a battery 2000, a battery power management protection board 1000′, and a load 9000 according to an embodiment of the present disclosure. The battery power management protection board 1000′ is connected between the battery 2000 and the load 9000. The battery power management protection board 1000′ could control the charging and discharging behaviors of the battery 2000 and could also provide protection for the battery 2000.

Please refer to FIG. 2, which illustrates a control waveform diagram during shutdown of the battery power management protection board 1000′ according to an embodiment of the present disclosure. At time point T21, when the battery power management protection board 1000′ intends to shut down, the discharge switch control voltage V200 will be pulled low. However, due to some remaining capacitance at the load end 9000 or within the battery power management protection board 1000′ itself, the discharge switch control voltage V200 may not drop quickly, resulting in a rather slow shutdown speed. As shown in the FIG. 2, the discharge switch control voltage V200 takes 45.6 seconds to fully drop.

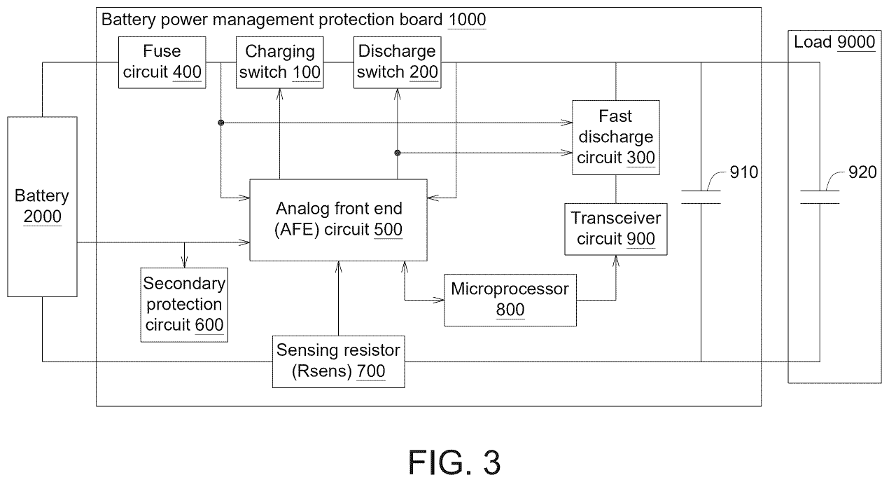

Please refer to FIG. 3, which illustrates a block diagram of the battery 2000, the battery power management protection board 1000, and the load 9000 according to an embodiment of the present disclosure. The battery power management protection board 1000 is connected between the battery 2000 and the load 9000. The battery power management protection board 1000 includes a charging switch 100, a discharge switch 200, a fast discharge circuit 300, a fuse circuit 400, an analog front end (AFE) circuit 500, a secondary protection circuit 600, a sensing resistor (Rsens) 700, a microprocessor 800, a transceiver circuit 900, and an internal capacitor 910. The load 9000 contains some capacitance 920. The charging switch 100 is used to control the charging behavior of the battery 2000. The discharge switch 200 is used to control the discharging behavior of the battery 2000. The fast discharge circuit 300 is used for fast shutdown. The fuse circuit 400 is used to protect the battery 2000 in case of short circuit. The analog front end circuit 500 is used for various control and judgment operations. The secondary protection circuit 600 provides secondary protection measures. The sensing resistor 700 is used for sensing. The microprocessor 800 is used for various computation processes. The transceiver circuit 900 is used to communicate with the load 9000.

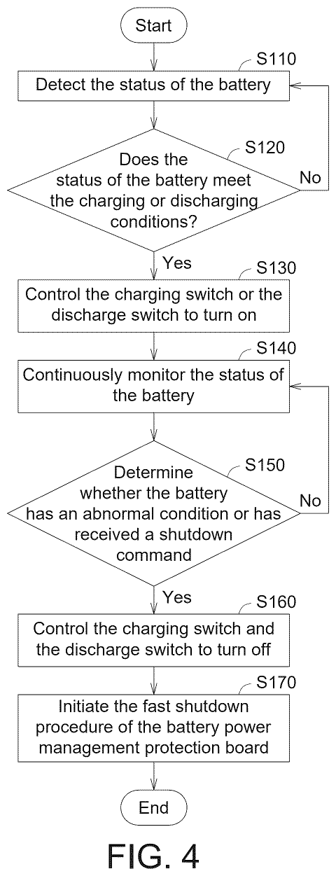

Please refer to FIG. 4, which illustrates a flowchart of the operation method of the battery power management protection board 1000 according to an embodiment of the present disclosure. The operation method of the battery power management protection board 1000 includes steps S110 to S170. In the step S110, the status of the battery 2000 is detected, for example, voltage, current, and temperature.

Then, in the step S120, the analog front end circuit 500 determines whether the status of the battery 2000 meets the charging or discharging conditions.

Next, in the step S130, the analog front end circuit 500 controls the charging switch 100 or the discharge switch 200 to turn on, to perform charging or discharging operation.

Then, in the step S140, the status of the battery 2000 is continuously monitored, for example, voltage, current, and temperature.

Next, in the step S150, whether the battery 2000 has an abnormal condition or has received a shutdown command is determined. If the abnormal condition occurs or the shutdown command is received, the process proceeds to the step S170.

In the step S160, the analog front end circuit 500 controls the charging switch 100 and the discharge switch 200 to turn off.

Then, in the step S170, the fast shutdown procedure of the battery power management protection board 1000 is initiated. In the step S170, the aforementioned fast discharge circuit 300 is used to shorten the shutdown time of the battery power management protection board 1000 to implement the fast shutdown procedure. The detailed components and operation of the fast discharge circuit 300 are described below.

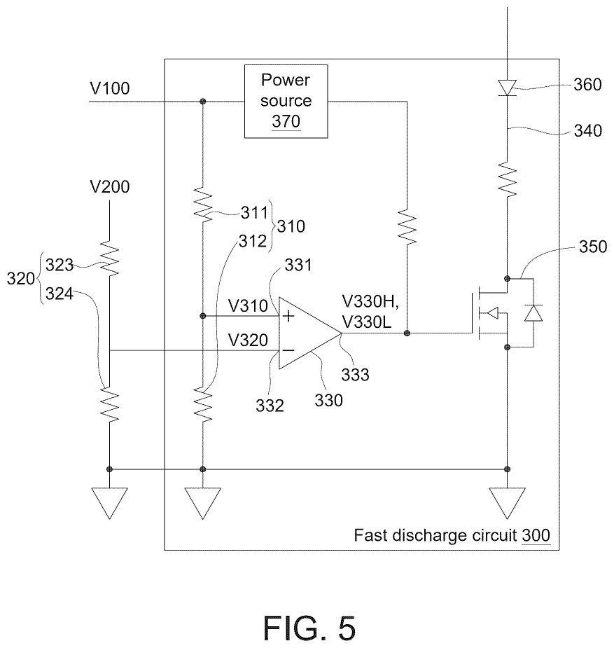

Please refer to FIG. 5, which illustrates a detailed circuit diagram of the fast discharge circuit 300 according to an embodiment. The fast discharge circuit 300 includes a first voltage divider circuit 310, a second voltage divider circuit 320, a comparator 330, a ground path 340, a ground path switch 350, a diode 360, and a power source 370. The first voltage divider circuit 310 includes a first resistor 311 and a second resistor 312. The second voltage divider circuit 320 includes a third resistor 323 and a fourth resistor 324. The comparator 330 has a first input terminal 331, a second input terminal 332, and an output terminal 333.

The first resistor 311 is connected to the battery 2000. The second resistor 312 is connected in series to the first resistor 311. A node between the first resistor 311 and the second resistor 312 is connected to the first input terminal 331 of the comparator 330. The third resistor 323 is connected to the battery 2000. The fourth resistor 324 is connected in series to the third resistor 323. A node between the third resistor 323 and the fourth resistor 324 is connected to the second input terminal 332 of the comparator 330.

The ground path switch 350 is connected between the output terminal 333 of the comparator 330 and the ground path 340. The diode 360 is disposed on the ground path 340.

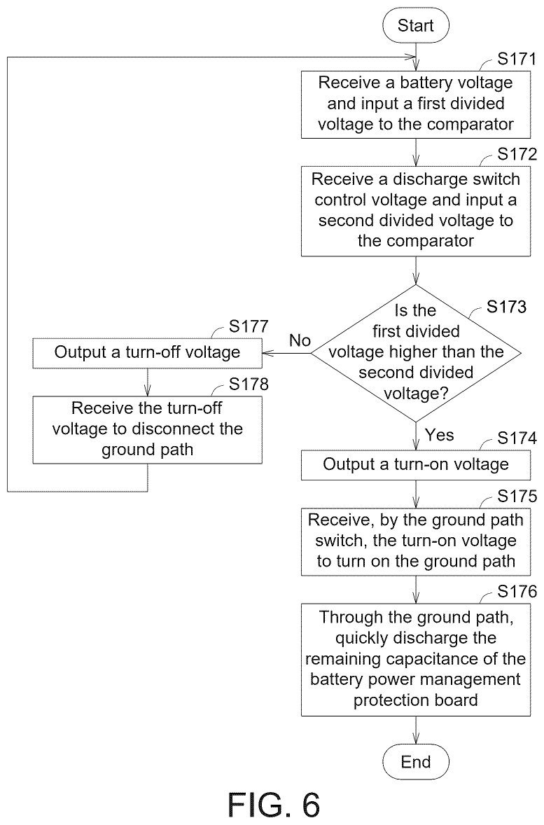

Please refer to FIG. 6, which illustrates a detailed flowchart of the fast shutdown method (i.e., the step S170) of the battery power management protection board 1000 according to an embodiment of the present disclosure. The fast shutdown method of the battery power management protection board 1000 includes steps S171 to S178. In the step S171, as shown in the FIG. 5, the first voltage divider circuit 310 receives a battery voltage V100 and inputs a first divided voltage V310 to the comparator 330.

In the step S172, as shown in the FIG. 5, the second voltage divider circuit 320 receives a discharge switch control voltage V200 and inputs a second divided voltage V320 to the comparator 330. The step S171 and the step S172 could be performed synchronously.

Next, in the step S173, as shown in the FIG. 5, the comparator 330 determines whether the first divided voltage V310 is higher than the second divided voltage V320. If the first divided voltage V310 is higher than the second divided voltage V320, the process proceeds to the step S174; if not, the process proceeds to the step S177.

In the step S174, the comparator 330 outputs a turn-on voltage V330H.

After the step S174, the process proceeds to the step S175. As shown in the FIG. 5, the ground path switch 350 receives the turn-on voltage V330H to turn on the ground path 340.

After the step S175, the process proceeds to the step S176. As shown in the FIG. 5, through the ground path 340, the remaining capacitance of the battery power management protection board 1000 is quickly discharged.

In the step S177, as shown in the FIG. 5, the comparator 330 outputs a turn-off voltage V330L.

After the step S177, the process proceeds to the step S178. As shown in the FIG. 5, the ground path switch 350 receives the turn-off voltage V330L to disconnect the ground path 340.

According to the above fast discharge method, when the discharge switch control voltage V200 drops, causing the first divided voltage V310 to be higher than the second divided voltage V320, the steps S174 to S176 could be entered to quickly discharge the remaining capacitance of the battery power management protection board 1000, thereby improving the shutdown speed of the battery power management protection board 1000.

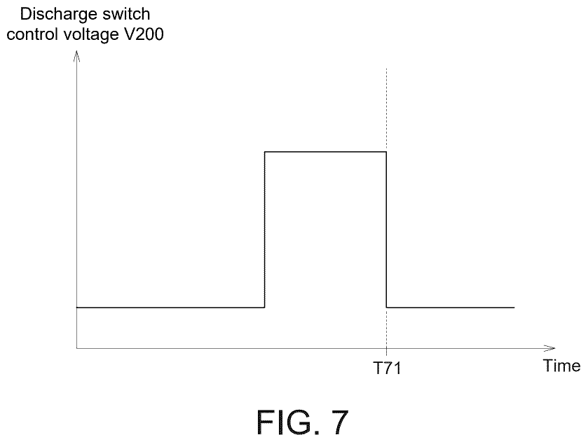

Please refer to FIG. 7, which illustrates a control waveform diagram during shutdown of the battery power management protection board 1000 using the fast discharge circuit 300 according to an embodiment of the present disclosure. At time point T71, when the battery power management protection board 1000 intends to shut down, the fast discharge circuit 300 activates the ground path 340. Although there may be some remaining capacitance at the load end 9000 or within the battery power management protection board 1000, the activated ground path 340 can quickly release the remaining capacitance, thereby effectively improving the shutdown speed. As shown in the FIG. 7, the discharge switch control voltage V200 takes only 0.1 seconds to fully drop.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A quick shutdown method for a battery power management protection board, comprising:
receiving a battery voltage to input a first divided voltage to a comparator;
receiving a discharge switch control voltage to input a second divided voltage to the comparator;
outputting a conduction voltage, if the comparator determines that the first divided voltage is higher than the second divided voltage;
receiving, by a ground path switch, the conduction voltage to turn on a ground path; and
discharging a remaining capacitance of the battery power management protection board rapidly through the ground path.

2. The quick shutdown method for the battery power management protection board according to claim 1, further comprising:
outputting a shutoff voltage, if the comparator determines that the first divided voltage is not higher than the second divided voltage.

3. The quick shutdown method for the battery power management protection board according to claim 2, wherein the ground path switch receives the shutoff voltage to disconnect the ground path.

4. The quick shutdown method for the battery power management protection board according to claim 1, wherein the step of receiving the battery voltage to input the first divided voltage to the comparator and the step of receiving the discharge switch control voltage to input the second divided voltage to the comparator are performed synchronously.

5. A quick discharge circuit, disposed in a battery power management protection board, wherein the quick discharge circuit comprises:
a first voltage dividing circuit, connected to a battery, for receiving a battery voltage and outputting a first divided voltage;
a second voltage dividing circuit, connected to a discharge switch, for receiving a discharge switch control voltage and outputting a second divided voltage;
a comparator having a first input terminal, a second input terminal, and an output terminal, wherein the first input terminal is connected to the first voltage dividing circuit to receive the first divided voltage, and the second input terminal is connected to the second voltage dividing circuit to receive the second divided voltage;
a ground path; and
a ground path switch, connected between the output terminal of the comparator and the ground path;
wherein when the comparator determines that the first divided voltage is higher than the second divided voltage, the comparator outputs a conduction voltage to the ground path switch to turn on the ground path; and
through the ground path, a remaining capacitance of the battery power management protection board is discharged rapidly.

6. The quick discharge circuit according to claim 5, further comprising:
a diode, disposed in the ground path.

7. The quick discharge circuit according to claim 5, wherein the first voltage dividing circuit comprises:
a first resistor, connected to the battery; and
a second resistor, connected in series with the first resistor.

8. The quick discharge circuit according to claim 7, wherein a node between the first resistor and the second resistor is connected to the first input terminal of the comparator.

9. The quick discharge circuit according to claim 7, wherein the second voltage dividing circuit comprises:
a third resistor, connected to the battery; and
a fourth resistor, connected in series with the third resistor.

10. The quick discharge circuit according to claim 9, wherein a node between the third resistor and the fourth resistor is connected to the second input terminal of the comparator.

11. The quick discharge circuit according to claim 5, wherein when the first divided voltage is not higher than the second divided voltage, the comparator outputs a shutoff voltage.

12. The quick discharge circuit according to claim 5, wherein the first voltage dividing circuit and the second voltage dividing circuit synchronously output the first divided voltage and the second divided voltage.

13. A battery power management protection board, connected to a battery, wherein the battery power management protection board comprises:
a discharge switch, connected to the battery; and
a quick discharge circuit, comprising:
a first voltage dividing circuit, connected to the battery, for receiving a battery voltage and outputting a first divided voltage;
a second voltage dividing circuit, connected to the discharge switch, for receiving a discharge switch control voltage and outputting a second divided voltage;
a comparator, having a first input terminal, a second input terminal, and an output terminal, wherein the first input terminal is connected to the first voltage dividing circuit to receive the first divided voltage, and the second input terminal is connected to the second voltage dividing circuit to receive the second divided voltage;
a ground path; and
a ground path switch, connected between the output terminal of the comparator and the ground path;
wherein when the comparator determines that the first divided voltage is higher than the second divided voltage, the comparator outputs a conduction voltage to the ground path switch to turn on the ground path; and
through the ground path, a remaining capacitance of the battery power management protection board is discharged rapidly.

14. The battery power management protection board according to claim 13, wherein the quick discharge circuit further comprises:
a diode, disposed in the ground path.

15. The battery power management protection board, according to claim 13, wherein the first voltage dividing circuit comprises:
a first resistor, connected to the battery; and
a second resistor, connected in series with the first resistor.

16. The battery power management protection board according to claim 15, wherein a node between the first resistor and the second resistor is connected to the first input terminal of the comparator.

17. The battery power management protection board according to claim 15, wherein the second voltage dividing circuit comprises:
a third resistor, connected to the battery; and
a fourth resistor, connected in series with the third resistor.

18. The battery power management protection board according to claim 17, wherein a node between the third resistor and the fourth resistor is connected to the second input terminal of the comparator.

19. The battery power management protection board according to claim 13, wherein when the first divided voltage is not higher than the second divided voltage, the comparator outputs a shutoff voltage.

20. The battery power management protection board according to claim 13, wherein the first voltage dividing circuit and the second voltage dividing circuit synchronously output the first divided voltage and the second divided voltage.
